(19) United States
(12) Patent Application Publication
(10) Pub. No.: US 2013/0040546 A1
(43) Pub. Date: Feb. 14, 2013

(54) AIRCRAFT AND METHOD FOR CLIMATIZING AT LEAST A PART-REGION OF THE INTERIOR OF AN AIRCRAFT

(71) Applicants: Iris Nöske, Rosenheim (DE); Gunnar Grün, Munchen (DE)

(72) Inventors: Iris Nöske, Rosenheim (DE); Gunnar Grün, Munchen (DE)

(21) Appl. No.: 13/635,712

(22) PCT Filed: Mar. 17, 2011
(86) PCT No.: PCT/EP11/54053

§ 371 Date: Oct. 24, 2012

(30) Foreign Application Priority Data
Mar. 20, 2010 (DE) 102010012143.6

(51) Int. Cl. B64D 13/00

(52) U.S. Cl. 454/76

(57) ABSTRACT

An aircraft including a fuselage having at least one seat frame attached to a seating surface. A seat including a seating surface, backrest and armrest. An air supply channel including an outflow element coupled to the seat providing air flow to the interior of the aircraft, and an exhaust air channel including an inflow element disposed on the ceiling of the aircraft interior. Climate control is provided for at least a partial area of the interior of the aircraft by supplying air into the interior through an outflow element which is part of a seat, and exhaust air is drawn off at least at the ceiling of the interior.

### BACKGROUND

The invention relates to an aircraft having at least one supply air duct and at least one exhaust air duct and at least one seat, wherein the supply air duct and the exhaust air duct and the seat are disposed in the interior of the aircraft and the seat contains a seat frame, with which the seat is fastened to a part of the fuselage, and a seat cushion and/or an optional backrest and/or an optional armrest.

An aircraft of the type stated in the introduction is known from DE 10 2007 049 926 A1. According to this prior art, the passenger cabin is fed supply air or conditioned air by means of a supply air duct in the floor region. This air is then warmed by the passengers and other thermal loads and consequently rises within the cabin. At the highest point of the cabin is found a exhaust air duct, via which the spent air is extracted from the cabin.

This previously known climatization system does not however allow individual influencing of the air quality or air quantity by the individual passengers. The object of the invention is to allow individual passengers or users of the aircraft an individual climate control.

### SUMMARY

According to the invention, it is proposed to feed the supply air to the interior of an aircraft via at least one outflow element, which is connected to at least one aircraft seat or is part of the aircraft seat. In this way, a microclimate, which covers roughly a spatial area occupied by an individual passenger, can be created within the aircraft cabin. The cabin climatization can thus be influenced individually by the respective passenger. Furthermore, the proposed ventilation or climatization system avoids the occurrence of draft air, so that the wellbeing of the passengers within the aircraft is enhanced.

In one embodiment of the invention, the outflow element can be fitted under the seat cushion. In this embodiment, the outflow element can be arranged to introduce an air flow in the direction of the floor of the interior or in proximity to the floor of the aircraft. In this way, a displacement flow is formed beneath the seat, so that the supplied supply air rises slowly alongside the passengers. The occurrence of draft air can hereby be reliably prevented. By proximity to the floor is understood, in some embodiments of the invention, a zone between 0 cm and 30 cm. In other embodiments of the invention, the term proximate to the floor denotes a zone between 10 cm and 25 cm or between 15 cm and 20 cm, respectively measured from the cabin floor. In some embodiments of the invention, the supply air is introduced proximate to the floor, yet the air flow is not, or not fully directed in the direction of the cabin floor.

In some embodiments of the invention, the aircraft or the seat frame can further have an intermediate air duct having a first end and a second end, wherein the first end of the intermediate air duct is connected to the supply air duct and the second end of the intermediate air duct is connected to the outflow element. In this way, the outflow element can be arranged freely in the region of the seat.

In some embodiments of the invention, the outflow element can be integrated in the seat cushion and/or the backrest and/or the armrest of the seat. As a result, a heating and/or ventilation of the contact area of the passenger with the seat is realized. A build-up of heat between the body of the passenger and the seat is thereby reliably prevented. In other embodiments of the invention, supply air can be led up through the upper part of the seat back directly into the head region of the passenger. In further embodiments of the invention, an outflow element can be arranged in the backrest of the seat such that this provides supply air for the passenger seated behind it.

In some embodiments of the invention, the aircraft can further have a exhaust air duct running on the ceiling of the interior. In this way, the spent air, which has been warmed by the thermal loads present in the aircraft cabin, can rise through natural convection and be extracted at the highest point of the cabin. As thermal loads in the interior of the aircraft can qualify, in particular, the passengers and the electrical energy consuming devices disposed in the interior. In particular, this can be the installed entertainment electronics.

In some embodiments of the invention, the aircraft further has at least one control device, by means of which the air quantity discharged from the outflow elements and/or the air temperature and/or the flow can be influenced. In some embodiments of the invention, the control device can be disposed within reach of the passenger, so that he can influence the air quantity flowing out from his seat or in the region of his seat and/or the temperature and/or flow velocity thereof. The control device can in some embodiments of the invention also be a regulating device or contain a regulating device, so that the air quantity, the air temperature and/or the flow velocity can be adjusted to predefinable desired values.

The air supplied via the at least one supply air duct and the outflow elements can in some embodiments of the invention be a mixing air conditioned in a mixing air system. The waste air removed from the cabin via the exhaust air duct can be fed at least partially to the mixing air system. Furthermore, supply air can be fed to the mixing air system. In some embodiments, the supply air can be supplied by means of a compressor. In some embodiments, the supply air can contain or consist of engine bleed air. The air conditioned in the mixing air-system is then fed back to the cabin via the supply air duct and the outflow elements. The conditioning of the air can comprise a filtering and/or a humidification and/or further measures.

### BRIEF DESCRIPTION OF THE DRAWINGS

The invention shall be explained in greater detail below with reference to figures without limitation of the general inventive concept, wherein:

FIG. 1 shows a cross section through the fuselage of an aircraft equipped with the climatization system according to the invention,

FIG. 2 shows the side view of a seat equipped according to the invention,

FIG. 3 shows an embodiment of an outflow element.

### DESCRIPTION OF PREFERRED EMBODIMENTS

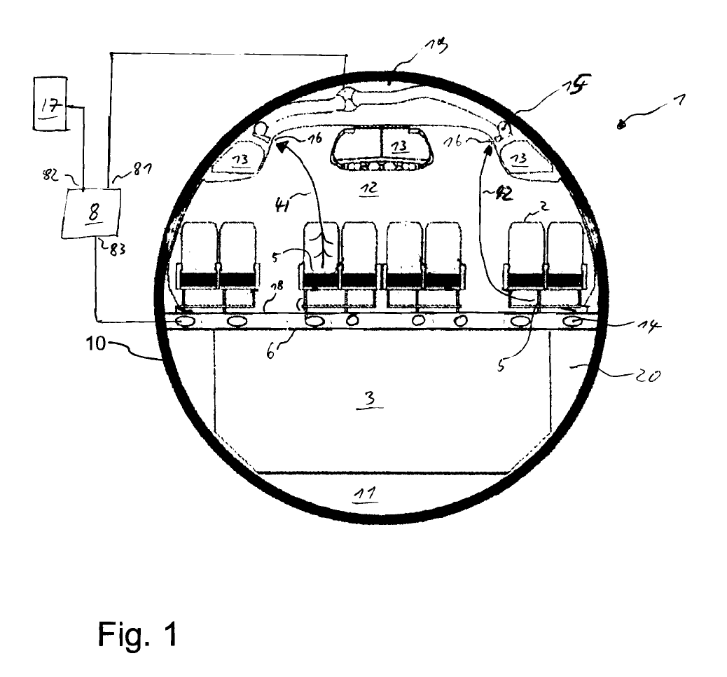

FIG. 1 shows a cross section through the fuselage 10 of an aircraft 1. The fuselage 10 is divided by an intermediate floor 18. Beneath the intermediate floor 18 is disposed a cargo hold 3. Above the intermediate floor 18 is located a passenger cabin 12.

The cargo hold 3, the bilge 11, the triangular region 20 and the passenger cabin 12 are pressurized with compressed air in cruising flight at high altitudes, so that the internal pressure in the fuselage 10 is greater than the pressure of the surrounding atmosphere. Furthermore, the cargo hold 3, the bilge 11, the triangular region 20 and the passenger cabin 12 can be climatized to a predefinable temperature and/or a regular air exchange and/or an air conditioning can be realized. In the passenger cabin 12, oxygen is consumed by the passengers and CO₂ given off. Also located in the passenger cabin 12 is electronic equipment, which generates additional thermal loads, for instance an inflight entertainment system. The demands on the climatization are therefore normally greater in the passenger cabin 12 than in the other regions. In some embodiments, the climatization can therefore be limited to the passenger cabin 12. For the passenger cabin 12, the term “interior” is therefore used synonymously in the following description.

In the interior 12, seats 2 are found. A 2-4-2 configuration is represented. Of course, the invention is not limited to this seat arrangement. Rather, other seat arrangements can also be provided. Above the seats 2 in the direction of the cabin ceiling 19 are found optional bins 13, which serve to receive the hand baggage of the passengers.

Beneath or within the intermediate floor 18 is found at least one supply air duct 14. In the represented embodiment, 8 supply air ducts are provided by way of example. In other embodiments of the invention, the number of supply air ducts can be larger or smaller and in some embodiments lie between 1 and 60. In some embodiments of the invention, the form of the cross section of the supply air ducts can vary.

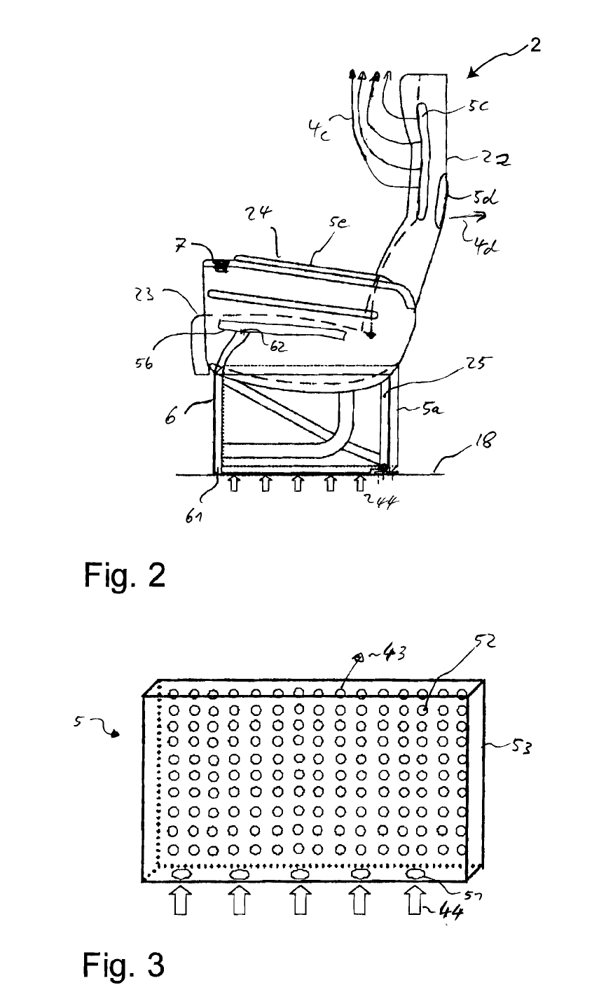

On the seat 2 is found at least one outflow element 5, as is explained in yet greater detail in connection with FIG. 2. The outflow element 5 serves to feed air to the interior from at least one supply air duct 14. Furthermore, the outflow element 5 can influence the air quantity fed to the cabin, or the blow-out direction, through the use of corresponding control elements. As a control element, a flap and/or a nozzle and/or a plurality of movable fins can be used. The outflow element 5 is connected up to at least one supply air duct 14, so that the air flowing in the supply air duct 14 can be discharged through the outflow element 5 into the passenger cabin 12.

In FIG. 1, an outflow element 5 disposed in the floor region or on the seat frame is represented on the port side of the aircraft. This outflow element produces a displacement flow 42 beneath the associated seat 2, so that the spent air rises upward in the direction of the cabin ceiling 19. With reference to the center row, on the starboard side of the aircraft the working method of a further outflow element 5 is shown. The outflow element 5 is located in the seat cushion and/or the seat back of the seat 2. The air is drawn from a supply air duct 14 and fed to the outflow element 5 via an intermediate air duct 6. The air then flows out of the seat cushion and/or the seat back between the contact area of the passenger and the seat and forms a rising air flow 41, which likewise flows in the direction of the cabin ceiling 19. With such a flow, an individual heating and/or ventilation can be performed at the site of the passenger.

The rising air flows 41 and 42 are extracted via at least one exhaust air duct 15. Between the exhaust air duct 15 and the interior 12 can be arranged ventilating elements 16, which can influence the air quantity fed to the exhaust air duct 15.

In some embodiments, the aircraft 1 can be provided with a mixing air system 8. The mixing air system 8 here has at least two inlets 81 and 82 and at least one outlet 83 auf. At the first inlet 81, the air from the exhaust air duct 15 is fed at least partially to the mixing air system 8. It can here be provided to lead off a part of the air present in the exhaust air duct 15 via an outlet valve into the open air and replace it by supply air, so that the air quantity in the cabin remains constant. In some embodiments, the air drawn from the exhaust air duct 15 can be conditioned prior to re-entry into the cabin. The conditioning can comprise, for instance, a filtering of dust particles or germs. In some embodiments, the conditioning can also comprise a drying and/or humidification.

At the second inlet 82 of the mixing air system 8, supply air can be supplied. Due to the low ambient pressure at high altitudes, the supply air at the inlet 82 can be brought to increased pressure by means of a compressor 17. In some embodiments of the invention, the compressor of at least one engine, which provides compressed and warmed engine bleed air at the second inlet 82, can be used as the compressor 17.

The outlet 83 of the mixing air systems 8 is in this case connected to the at least one supply air duct 14, which relays to the outflow elements 5 the air provided by the mixing air system 8.

FIG. 2 shows an aircraft seat 2 which is known per se. The seat 2 has a seat cushion 23 and a seat back 22. The back 22 can be movably connected to the seat cushion 23 and be individually adjusted by the passenger. The seat 2 can further have an armrest 24. The armrest 24 can be fixedly or movably connected to the seat 2. The seat 2 is connected to the floor 18 of the interior 12 by means of a seat frame 25.

In FIG. 2, the seat 2 further has a plurality of outflow elements 5 auf. Each represented outflow element does not have to be present in every embodiment of the invention. Rather, in some embodiments of the invention, only individual outflow elements 5 can be disposed on the seat 2. In other embodiments of the invention, a plurality of outflow elements 5 can also be provided.

The outflow element 5a is located on the side of the seat frame 25. The outflow element 5a can be arranged to produce a displacement flow beneath the seat 2 or beneath the seat cushion 23, so that the spent air rises in the direction of the cabin ceiling 19. An outflow element 5b can be disposed within or beneath the seat cushion 23. The outflow element 5b can produce an upwardly directed flow, which is discharged through the seat cushion 23 and thus allows direct heating and/or cooling and/or ventilation of the contact area between the seat 2 and the passenger. In other embodiments of the invention, the outflow element 5b can alternatively or additionally produce a flow directed downward in the direction of the cabin floor 18, or an air flow admitted in proximity to the floor, in order thereby to provide a displacement flow, as explained in connection with the outflow element 5a. In the seat back 22 can be provided an outflow element 5c, which provides a forwardly directed flow 4c. The flow 4c can likewise enable the ventilation, cooling and/or heating of that part-surface of the backrest 22 which is in contact with the passenger. In the backrest 22 can further be disposed an outflow element 5d, which produces a flow 4d. The flow 4d here serves to ventilate the air space of that passenger who uses the seat behind the represented seat 2.

As is represented with reference to the element 5a, the outflow elements 5 can be directly connected to a supply air duct beneath the cabin floor 18. Insofar as the outflow elements have a greater distance from the cabin floor 18, for instance the outflow element 5b, these can be connected to the supply air duct 14 running beneath the floor 18 by means of an intermediate air duct 6. To this end, the intermediate air duct 6 has at least one first end 61 and at least one second end 62. Here the first end 61 is connected up to the supply air duct 14 and the second end 62 is connected to the outflow element 5b. In the same way, the outflow elements 5c, 5d and 5e can also be connected by further intermediate air ducts 6 to the supply air duct 14. The intermediate air duct 6 can run along the seat frame 25 or be, as a tubular element, a direct component part of the seat frame 25. In this case, the first end 61 can be part of the fastening system of the seat frame 25 to the floor 18 of the interior and thus, at the same time, provide a fluid-tight connection to the supply air duct 14 and a mechanical fastening.

Furthermore, an outflow element 5e can be disposed in the armrest 24. Such an outflow element 5e allows the passenger to influence the microclimate in the region of his seat, so that the passenger can adjust his individual supply air supply and/or an individual temperature at his seat.

In some embodiments of the invention, a control device 7 can be provided in the armrest 24. With the control device 7, the passenger can individually influence the air quantity discharged from the outflow elements 5 of his seat 2 and/or the air temperature and/or the flow velocity and/or the outflow direction.

FIG. 3 shows one embodiment of an outflow element 5. The outflow element represented in FIG. 3 has a roughly cuboid hollow body 53. Of course, the basic shape of the hollow body 53 is chosen only by way of example and can in other embodiments of the invention assume a different form. Within the scope of the invention, modifications and changes can be made to the shape and number and arrangement of the openings in order to adapt the outflow element 5 to the respective installation situation at the seat 2. The hollow body can serve as an air distributor of the supply air and/or as an air mixer of different supply air flows and/or as a sound damper for reducing the outflow noises of the supply air.

The hollow body 53 has on its bottom side at least one opening 51, by means of which it is connected up to at least one supply air duct 14. The connection between the openings 51 and the supply air duct 14 can be created directly and/or be realized by means of further intermediate air ducts 6. Hence an air quantity 44 can enter into the interior of the outflow element 5 or its hollow body 53.

On a further outer face of the hollow body 53 is found at least one discharge opening 52. A greater number of discharge openings 52 is represented, which discharge openings are arranged roughly in a grid pattern on the discharge surface of the outflow element 5. A large air quantity with low flow velocity can hereby be admitted into the interior 12, so that disagreeable draft air phenomena and/or loud outflow noises are avoided. Finally, the air drawn from the supply air duct 14 flows via the discharge openings 52 as supply air 43 into the interior 12.

The outflow element 5 represented in FIG. 3 can be fastened, for instance as a laterally mounted outflow element 5a, to the seat frame 25, as is explained with reference to FIG. 2. Alternatively, the outflow element 5 represented in FIG. 3 can also be employed in a turned position within or beneath the seat cushion 23 and/or the seat back 22.

The invention is not, of course, limited to the embodiments represented in the figure and the illustrative embodiments. The above description should therefore not be regarded as limiting, but as illustrative. The following claims should be construed such that a named feature is present in at least one embodiment of the invention. This does not preclude the presence of further features. Insofar as the claims and the above description define “first” and “second” features, then this notation serves to differentiate between two similar features without stipulating an order of precedence.

1.-20. (canceled)

21. An aircraft comprising
at least one fresh air duct, which is disposed on the bottom of the interior,
at least one waste air duct, which is disposed on the ceiling of the interior,
at least one seat comprising at least one seat frame and at least one seat cushion and/or at least one optional backrest and/or at least one optional armrest,
at least one outflow element, by means of which air can be fed to the interior of the aircraft from the fresh air duct, said outflow element being arranged below the seat cushion,
at least one inflow element being located at the ceiling of the interior, by means of which air can be removed from the interior of the aircraft to the fresh air duct.

22. The aircraft according to claim 21, wherein the outflow element is adapted to introduce an air flow in the direction of the floor and/or in proximity to the floor of the interior of the aircraft.

23. The aircraft according to claim 21, further comprising at least one intermediate air duct having a first end and a second end, wherein
the first end of the intermediate air duct is connected to the fresh air duct and
the second end of the intermediate air duct is connected to the outflow element.

24. The aircraft according to claim 23, wherein the intermediate air duct is integrated in the seat frame.

25. The aircraft according to claim 21, wherein an additional outflow element is integrated in the seat cushion and/or the backrest and/or the armrest of the seat.

26. The aircraft according to claim 21, wherein the outflow element has a hollow body.

27. The aircraft as claimed in claim 26, wherein the hollow body is connected by at least one opening to at least one intermediate fresh air duct.

28. The aircraft according to claim 26, wherein the hollow body has a plurality of discharge openings.

29. The aircraft according to claim 21, further comprising at least one control device, by means of which the air quantity discharged from the outflow element and/or the air temperature and/or the flow velocity can be influenced.

30. The aircraft according to claim 21, further comprising at least one mixing air system having at least one first inlet, to which air can be fed from the waste air duct, and at least one second inlet, to which fresh air can be fed, and at least one outlet, which is connected to the fresh air duct.

31. An aircraft comprising
at least one fresh air duct, which is disposed on the bottom of the interior,
at least one waste air duct, which is disposed on the ceiling of the interior,
at least one seat comprising at least one seat frame and at least one seat cushion and/or at least one optional backrest and/or at least one optional armrest,
at least one outflow element, by means of which air can be fed to the interior of the aircraft from the fresh air duct, said outflow element being arranged below the seat cushion, and being adapted to introduce an air flow in the direction of the floor, causing a displacement flow under the seat,
at least one inflow element being located at the ceiling of the interior, by means of which air can be removed from the interior of the aircraft to the fresh air duct.

32. The aircraft according to claim 31, further comprising at least one intermediate air duct having a first end and a second end, wherein
the first end of the intermediate air duct is connected to the fresh air duct and
the second end of the intermediate air duct is connected to the outflow element.

33. The aircraft according to claim 32, wherein the intermediate air duct is integrated in the seat frame.

34. The aircraft according to claim 31, further comprising at least one control device, by means of which the air quantity discharged from the outflow element and/or the air temperature and/or the flow velocity can be influenced.

35. The aircraft according to claim 31, further comprising at least one mixing air system having at least one first inlet, to which air can be fed from the waste air duct, and at least one second inlet, to which fresh air can be fed, and at least one outlet, which is connected to the fresh air duct.

36. A method for climatizing at least a part-region of the interior of an aircraft, said method comprising the following steps:
feeding fresh air into the interior by means of at least one outflow element, the outflow element being part of a seat disposed in the interior of the aircraft, wherein a displacement flow is formed under the seat, so that the spent air rises in the direction of the cabin ceiling, and
extracting waste air at least on the ceiling of the interior.

37. The method according to claim 36, wherein an additional air discharge is realized from the seat cushion and/or the backrest and/or the armrest of the seat.

38. The method according to claim 36, wherein the discharged air quantity and/or the temperature and/or the velocity is influenced by means of a control device.

39. The method according to claim 36, wherein the air flow is directed to the floor and/or is introduced in proximity to the floor.

40. The method according to claim 36, wherein the air flow is introduced into a zone between 0 cm and 30 cm or wherein the air flow is introduced into a zone between 15 cm and 20 cm, respectively measured from the cabin floor.
